(19) United States
(12) Patent Application Publication
(10) Pub. No.: US 2009/0322658 A1
(43) Pub. Date: Dec. 31, 2009

(54) Information Processing Apparatus

(75) Inventor: Norikazu Nagasawa, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/469,574

(22) Filed: May 20, 2009

(30) Foreign Application Priority Data
Jun. 30, 2008 (JP) 2008-171420

(51) Int. Cl. G09G 3/32

(52) U.S. Cl. 345/82

(57) ABSTRACT

According to the invention, an information processing apparatus includes: a non-self-emission type display panel; a light source configured to apply light to the display panel; a light source driver configured to control luminance of the light source and provided independently from the display panel; and a flexible printed circuit board that connects the light source and the light source driver and has a plurality of terminals connected to the light source driver, wherein the terminals includes a plurality of cathode terminals and a plurality of anode terminals, the number of the cathode terminals being a multiple of three times of the number of the anode terminals.

### CROSS-REFERENCE TO RELATED APPLICATIONS

This application is based upon and claims the benefit of priority from Japanese Patent Application No. 2008-171420, filed Jun. 30, 2008, the entire contents of which are incorporated herein by reference.

### BACKGROUND

1. Field

The present invention relates to an information processing apparatus having a non-self-emission type display device.

2. Description of the Related Art

Among information processing apparatus such as personal computers and cell phones are apparatus that are equipped with a non-self-emission type display device such as a liquid crystal display device. In general, to improve the visibility of an image displayed on the display screen, non-self-emission type display devices have a light source(s) for applying light to the display screen (display panel) from the front side or the back side. The cold-cathode fluorescent lamp (CCFL) has mainly been used as such a light source. However, since mercury is used in the CCFL, with increased global concern about earth's environmental problems, light sources capable of replacing the CCFL are now desired.

The LED (light-emitting diode) is now attracting attention as one light source capable of replacing the CCFL. This is because the LED is lower in power consumption than the CCFL and is more environment-friendly than the latter because of non-use of mercury.

Where LEDs are used as light sources, a driver circuit for driving the LEDs is necessary. This is similar to the fact that where a CCFL(s) is used as a light source an inverter circuit for driving the CCFL is necessary.

JP-A-2005-267881 discloses a conventional display device having LEDs and an LED driver circuit as mentioned above.

A surface illumination device disclosed in JP-A-2005-267881 is equipped with a light guide plate, plural point light sources (LEDs) that are opposed to one side surface of the light guide plate, a first flexible printed circuit board (FPC) mounted with the plural LEDs, and a second FPC which connects the first FPC to an LED driver circuit board on which an LED driver circuit is formed. The second FPC is connected to the LED driver circuit board via connectors that are provided on them, respectively. In this surface illumination device, the plural LEDs can be disposed on the first FPC so as to be held at proper positions easily and reliably.

However, in the above conventional technique, no consideration is given to a case that the size of the display device is changed, that is, the number of LEDs is changed. Therefore, in the conventional technique, when the number of LEDs is changed, the connectors provided on the LED driver circuit board and the second FPC which connects the first FPC to the LED driver circuit board need to be changed to ones having a new pin assignment.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic view showing the entire configuration of an information processing apparatus according to an embodiment of the present invention.

FIG. 2 is an exemplary schematic block diagram showing example internal configurations of a computer main body and a display device shown in FIG. 1.

FIG. 3 is an exemplary schematic block diagram showing an example internal configuration of a display device having a CCFL as a light source.

FIG. 4A is an exemplary schematic block diagram showing an example internal configuration of a first conventional display device having an LED group as light source.

FIG. 4B is an exemplary schematic block diagram showing an example internal configuration of a second conventional display device having an LED group as light sources.

FIG. 5 is an exemplary graph of power-luminance characteristics of an LED and a CCFL (CCFL).

FIG. 6 illustrates an example manner how an FPC whose one end is connected to an LED group is led out of an LCD panel in the display device shown in FIG. 2.

FIG. 7 illustrates an example pin assignment of a connector of the FPC.

FIG. 8 illustrates an example manner how LED subgroups of an LED group are connected to each other in parallel.

FIG. 9 illustrates an example of LED connections in a case that 48 LEDs constitute the LED group.

FIG. 10 illustrates an example of LED connections in a case that 88 LEDs constitute the LED group.

FIG. 11 illustrates an example manner how the series LEDs that are connected to each cathode terminal are arranged so as not to be adjacent to each other.

### DETAILED DESCRIPTION

Various embodiments according to the invention will be described hereinafter with reference to the accompanying drawings. In general, according to one embodiment of the invention, an information processing apparatus includes: a non-self-emission type display panel; a light source configured to apply light to the display panel; a light source driver configured to control luminance of the light source and provided independently from the display panel; and a flexible printed circuit board that connects the light source and the light source driver and has a plurality of terminals connected to the light source driver, wherein the terminals includes a plurality of cathode terminals and a plurality of anode terminals, the number of the cathode terminals being a multiple of three times of the number of the anode terminals.

An information processing apparatus according to an embodiment of the present invention will be hereinafter described with reference to the accompanying drawings.

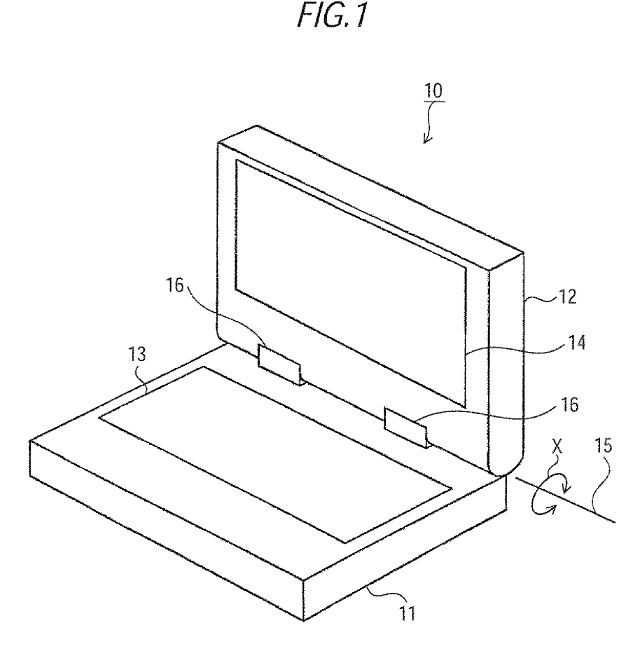

FIG. 1 is a schematic view showing the entire configuration of the information processing apparatus according to the embodiment of the invention. In the following, a notebook personal computer which is equipped with a liquid crystal display device having LEDs (light-emitting diodes) as light sources will be described as an example information processing apparatus.

The information processing apparatus 10 is equipped with a computer main body 11 and a display device 12.

The computer main body 11 has a thin, box-shaped body, and a keyboard 13 as an input unit is provided on the top surface of the body so as to occupy a central area. The display device 12 incorporates a liquid crystal display panel (hereinafter referred to as an LCD panel) 14 as a non-self-emission type display panel. The display device 12 is connected to the computer main body 11 via connecting members (hinges) 16 so as to be able to rotate about an opening/closing axis 15 in the directions of arrow X to open or close the computer main body 11.

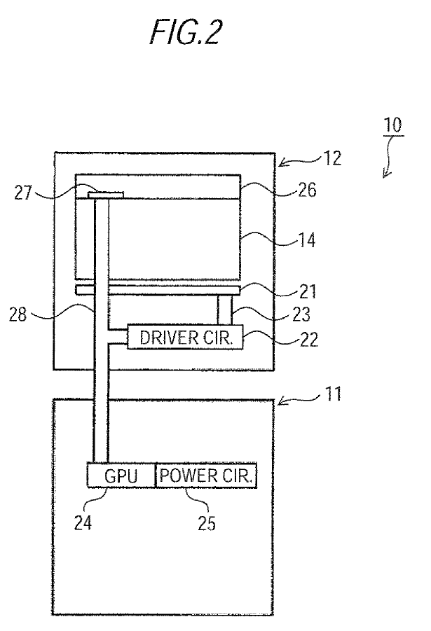

FIG. 2 is a schematic block diagram showing example internal configurations of the computer main body 11 and the display device 12 shown in FIG. 1.

The display device 12 has the LCD panel 14, an LED group 21 as light sources for applying light to the LCD panel 14, a driver circuit 22 as a light source drive unit which is provided as a unit that is independent of the LCD panel 14 and controls the emission luminance of the LED group 21, and a flexible printed circuit board (FPC) 23 which connects the LED group 21 to the driver circuit 22.

The computer main body 11 has a GPU (graphics processing unit) 24 and a power circuit 25 for supplying power to the individual units of the display device 12.

As shown in FIG. 2, the GPU 24 is connected to the LCD panel 14 via a wiring 28 such as an FPC which is connected to an interface 27 provided on an LCD board 26. The GPU 24 thus controls display operation of the LCD panel 14. The GPU 24 is also connected to the driver circuit 22 via the wiring 28 and controls it.

Since the driver circuit 22 is provided as a unit that is independent of the LCD panel 14 and is incorporated in the body of the display device 12, when the light source of the display device 12 is changed from a CCFL to LEDs it is possible to continue to use, effectively, the members and units of the display device 12 that have been used together with the CCFL.

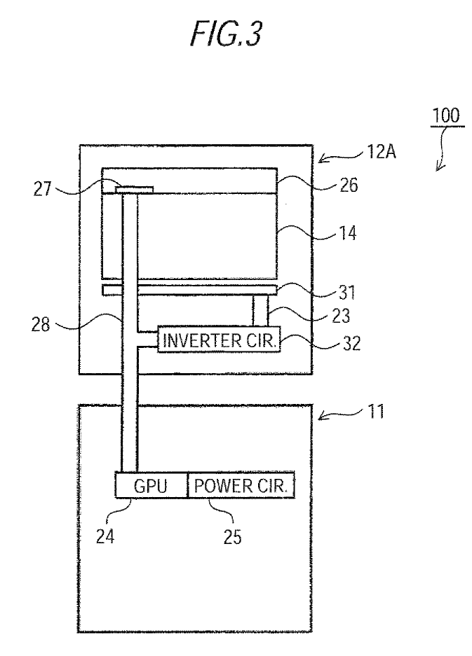

FIG. 3 is a schematic block diagram showing an example internal configuration of a display device 12a having a CCFL 31 as a light source.

As shown in FIG. 3, the display device 12a having the CCFL 31 as a light source has an LCD panel 14, the CCFL 31, an inverter circuit 32 which is provided as a unit that is independent of the LCD panel 14 and lights the CCFL 31, and an FPC 23 which connects the CCFL 31 to the inverter circuit 32.

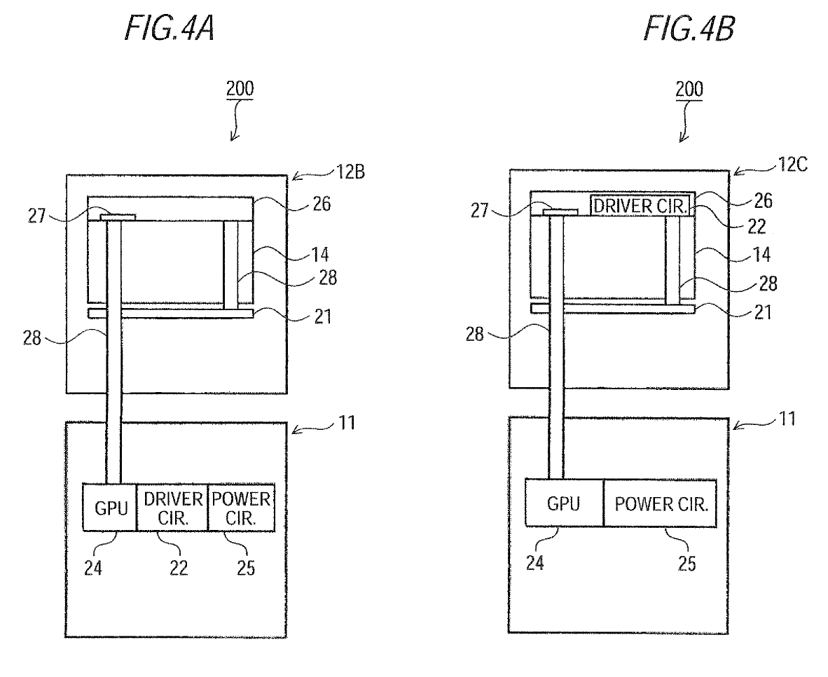

FIG. 4A is a schematic block diagram showing an example internal configuration of a first conventional display device 12b having an LED group 21 as light sources. FIG. 4B is a schematic block diagram showing an example internal configuration of a second conventional display device 12b having an LED group 21 as light sources.

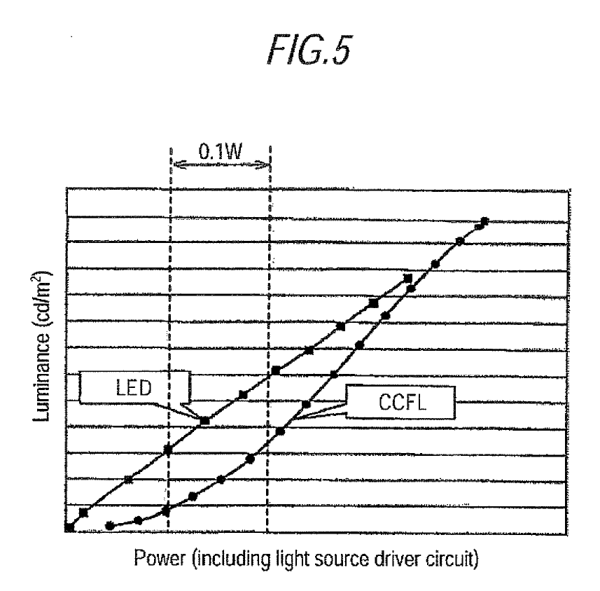

FIG. 5 is a graph of power-luminance characteristics of an LED and a CCFL.

The LED is lower in power consumption than the CCFL. FIG. 5 shows that the LED is lower in power consumption than the CCFL by about 0.1 W at 50 cd/m2. Furthermore, the LED is more earth-friendly than the CCFL because the latter necessarily contains mercury because of its principle. For these reasons, in recent years, LEDs have come to be used frequently as light sources in place of CCFL.

In many cases, conventional display devices having LEDs employ the configurations of FIGS. 4A and 4B. However, the configuration of FIG. 4A in which the driver circuit 22 is provided in the computer main body 11 and the configuration of FIG. 4B in which the driver circuit 22 is provided on the LCD board 26 are much different from the configuration of the display device 12a shown in FIG. 3 which uses the CCFL 31.

This is because in the conventional display devices 12b and 12c having the LEDs no consideration is given to the effective use of the members and units of the display device 12a having the CCFL 31. Therefore, when the light source is changed from the CCFL 31 to LEDs, in the case of the conventional display devices 12b or 12c having the LEDs a number of new members are necessary and a large part of the resources of the display device 12a having the CCFL 31 are rendered useless.

In contrast, as shown in FIG. 2, in the display device 12 according to the embodiment which uses the LEDs sufficient consideration is given to the effective use of the members and units of the display device 12a having the CCFL 31. The driver circuit 22 is provided as a unit that is independent of the LCD panel 14, and is incorporated in the body of the display device 12 together with the LCD panel 14. As a result, as is apparent from the comparison between FIGS. 2 and 3, the display device 12 according to the embodiment enables effective use of the resources of the display device 12a having the CCFL 31 when the light source is changed from the CCFL 31 to LEDs.

To use, more effectively, the members and units of the display device 12a having the CCFL 31, in the display device 12 shown in FIG. 2 it is preferable that the connection side, for connection to the wiring 28, of the driver circuit 22 be the same as that, for connection to the wiring 28, of the inverter circuit 32.

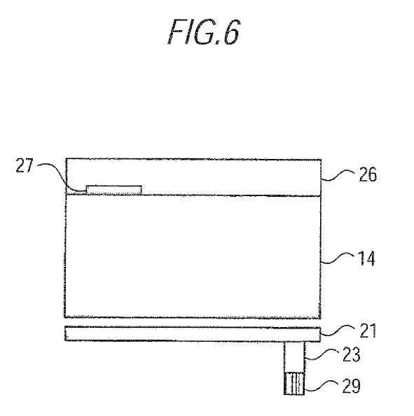

FIG. 6 illustrates an example manner how the FPC 23 whose one end is connected to the LED group 21 is led out of the LCD panel 14 in the display device 12 of FIG. 2.

To use, even more effectively, the members and units of the display device 12a having the CCFL 31, in the display device 12, as shown in FIG. 2, the position where the FPC 23 (which is electrically connected to the LED group 21) is led out of the LCD panel 14 is made same as in the display device 12a having the CCFL 31. The other end of the FPC 23 is provided with a connector 29 for connection to the driver circuit 22.

Next, a description will be made of a pin assignment of the connector 29 which is provided at the other end of the FPC 23 for connection to the driver circuit 22.

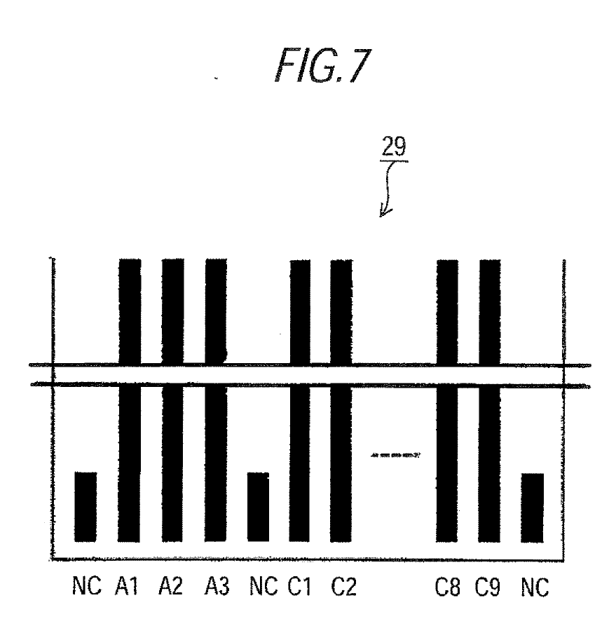

FIG. 7 illustrates an example pin assignment of the connector 29 of the FPC 23. In the example of FIG. 7, the connector 29 of the FPC 23 has three anode terminals A1-A3 and nine cathode terminals C1-C9.

As shown in FIG. 7, the pin assignment of the connector 29 is such that the cathode terminals C1-C9 are arranged adjacent to each other in the terminal arrangement direction to constitute a cathode terminal array and the anode terminals A1-A3 are arranged in the same direction to constitute an anode terminal array, and that a non-connection terminal NC is disposed between the cathode terminal array and the anode terminal array. As a result, the voltage levels can be made more stable than in a case that an end cathode terminal and an end anode terminal are adjacent to each other and short-circuiting can be prevented even when the connector 29 is inserted obliquely.

As shown in FIG. 7, the pin assignment of the connector 29 is such that non-connection terminals NC are disposed at both ends in the terminal arrangement direction. As a result, even if some trouble occurs in the pins located at both ends that receive a particularly heavy load when the connector 29 is inserted or removed, it does not influence the connection between the FPC 23 and the driver circuit 22.

Furthermore, since the connector 29 is provided with the plural cathode terminals C1-C9, it is possible to divide the LED group 21 into plural LED subgroups and connect the LED subgroups parallel with each other. As a result, the necessary voltage and current can be made lower or smaller than in the case that the LEDs of the LED group 21 are connected to each other in series, whereby the probability that the withstand voltage of the connector 29 or the FPC 23 is exceeded is made low and the LED group 21 can thus be driven more safely.

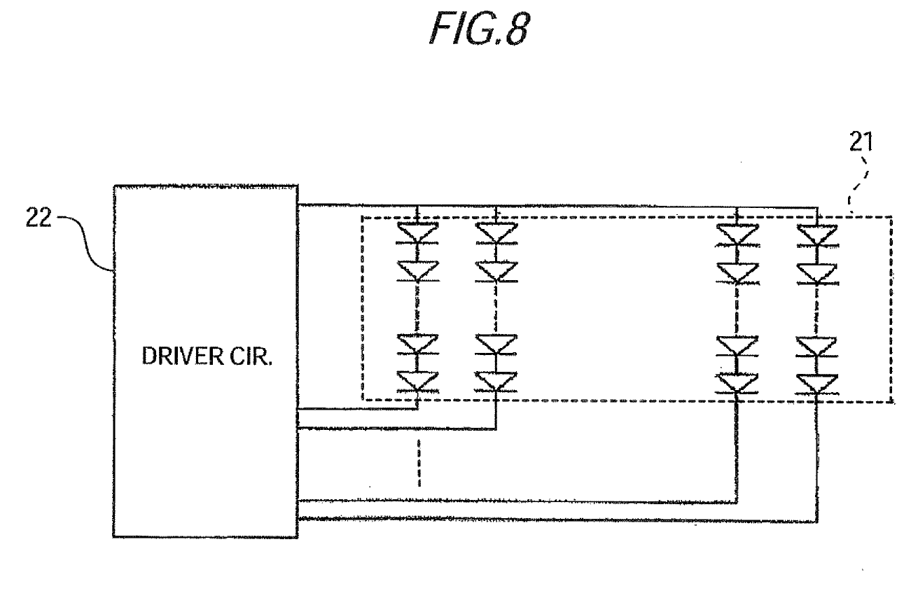

FIG. 8 illustrates an example manner how the LED subgroups of the LED group 21 are connected to each other in parallel.

As shown in FIG. 8, since the connector 29 is provided with the plural cathode terminals C1-C9, it is possible to divide the LED group 21 into plural LED subgroups and connect the LED subgroups parallel with each other. In view of the power efficiency, it is preferable that the numbers of LEDs of the respective LED subgroups be the same.

The connector 29 has the three anode terminals A1-A3 and the nine cathode terminals C1-C9. Therefore, the same connector 29 can be used even if the number of LEDs constituting the LED group 21 is changed. That is, the connector 29 can accommodate a wide range of the number of LEDs.

Setting the number of cathode terminals equal to a multiple of 3 times the number of anode terminals allows the connector 29 to accommodate a case of using RGB-LEDs and enhances its versatility.

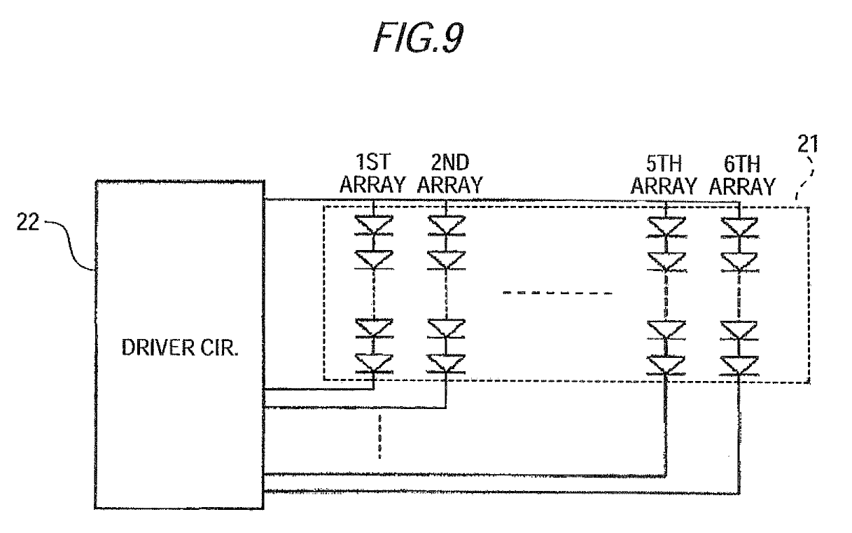

FIG. 9 illustrates an example of LED connections in a case that 48 LEDs constitute the LED group 21.

The driver circuit 22 is configured so as to be able to control currents for respective cathode terminals. Where the number of LEDs constituting the LED group 21 is small as in the case of FIG. 9, the connector 29 may be used in such a manner that the anode side has one contact and the cathode side has six contacts.

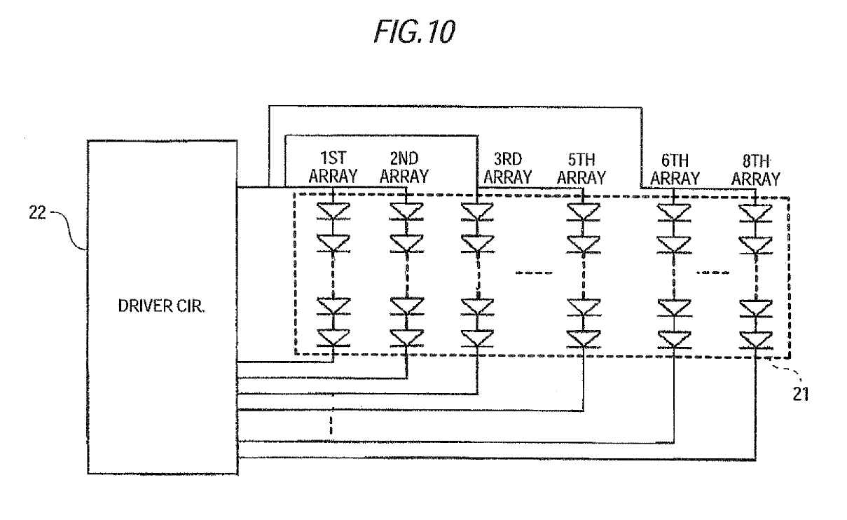

FIG. 10 illustrates an example of LED connections in a case that 88 LEDs constitute the LED group 21.

As shown in FIG. 10, even where the number of LEDs constituting the LED group 21 is large, the current load per contact can be kept low by, for example, causing the anode side and the cathode side to have three contacts and eight contacts, respectively.

It can therefore be said that as shown in FIGS. 9 and 10 the connector 29 can accommodate a wide range of the number of LEDs.

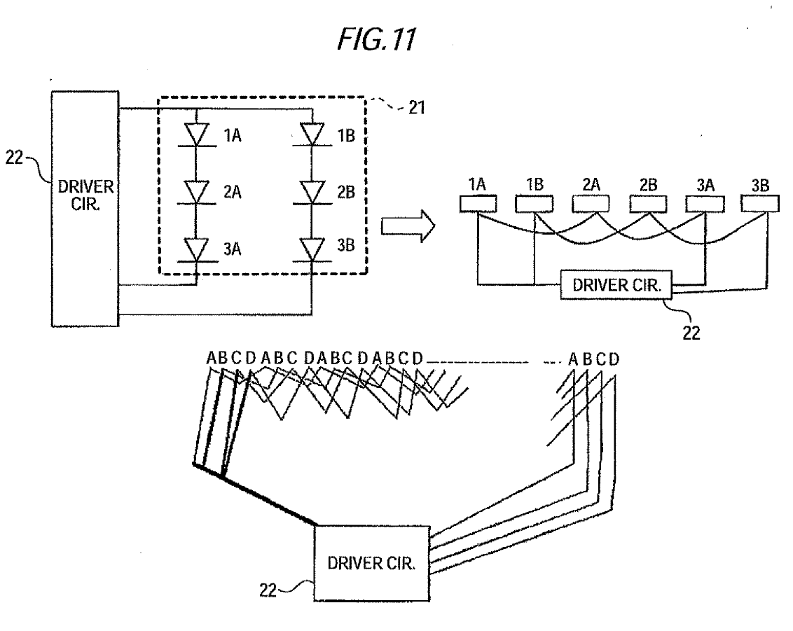

FIG. 11 illustrates an example manner how the series LEDs that are connected to each cathode terminal are arranged so as not to be adjacent to each other.

As shown in FIG. 11, consideration will be given to a case that the LED group 21 is composed of series LEDs 1A, 2A, and 3A which are connected to one cathode terminal and series LEDs 1B, 2B, and 3B which are connected to the other cathode terminal. In this case, if the LED 2A, for example, deteriorates, all the LEDs 1A, 2A, and 3A may be lowered in luminance. If the LEDs 1A, 2A, and 3A are arranged adjacent to each other, only a corresponding region of the LCD panel 14 becomes dark in a concentrated manner, which lowers the visibility to a user to a large extent.

In view of the above, as shown in FIG. 11, the series LEDs that are connected to each cathode terminal are arranged on an FPC or the like so as not to be adjacent to each other. This arrangement can prevent the problem that a portion of the LCD panel 14 becomes dark in a concentrated manner when one LED has deteriorated.

The invention is not limited to the above embodiment itself, and in a practice stage the invention can be implemented by modifying components without departing from the spirit and scope of the invention. Furthermore, various inventions can be made by properly combining plural components disclosed in the embodiment. For example, some components of the embodiment may be omitted.

As described with reference to the embodiment, there is provided an information processing apparatus having a non-self-emission type display device using a light source(s), the information processing apparatus being configured in such a manner that the pin assignment of a connector for connecting the light source to a light source driver circuit can accommodate a wide range of the number of light sources.

The information processing apparatus according to the embodiment, which is equipped with the non-self-emission type display device having the light source(s), is configured in such a manner that the pin assignment of the connector for connecting the light source to the light source driver circuit can accommodate a wide range of the number of light sources.

What is claimed is:

1. An information processing apparatus comprising:
a non-self-emission type display panel;
a light source configured to apply light to the display panel;
a light source driver configured to control luminance of the light source and provided independently from the display panel; and
a flexible printed circuit board that connects the light source and the light source driver and has a plurality of terminals connected to the light source driver,
wherein the terminals includes a plurality of cathode terminals and a plurality of anode terminals, the number of the cathode terminals being a multiple of three times of the number of the anode terminals.

2. The information processing apparatus according to claim 1,
wherein the light source driver is configured to control currents in the respective cathode terminals.

3. The information processing apparatus according to claim 2,
wherein the anode terminals are arranged adjacent to each other to form a anode terminal array,
wherein the cathode terminals are arranged adjacent to each other to form a cathode terminal array, and
wherein the terminals further include first non-connection terminal disposed between the cathode terminal array and the anode terminal array.

4. The information processing apparatus according to claim 3,
wherein the terminals further include a second non-connection terminal disposed adjacent to the cathode array and nonadjacent to the anode array and the first non-connection terminal, and
wherein the terminals further include a third non-connection terminal adjacent to the anode array and nonadjacent to the cathode array and the first non-connection terminal.

5. The information processing apparatus according to claim 4,
wherein the number of cathode terminals is nine, and
wherein the number of anode terminals is three.

6. The information processing apparatus according to claim 1,
wherein the light source includes a plurality of lighting members serially connected to one of the cathode terminal, the lighting members being arranged not to be adjacent to each other.
